(19) United States
(12) Patent Application Publication
(10) Pub. No.: US 2018/0240192 A1
(43) Pub. Date: Aug. 23, 2018

(54) LIFETIME INCOME PLATFORM

(71) Applicant: LIFETIME INCOME TECHNOLOGIES, INC., West Hartford, CT (US)

(72) Inventors: George A. Castineiras, West Hartford, CT (US); Narinder Makin, Hamden, CT (US); Alexander Isakov, Sudbury, MA (US); Ganesh Gupta, Trumbull, CT (US)

(73) Assignee: LIFETIME INCOME TECHNOLOGIES, INC., West Hartford, CT (US)

(21) Appl. No.: 15/897,343

(22) Filed: Feb. 15, 2018

Related U.S. Application Data
(60) Provisional application No. 62/459,239, filed on Feb. 15, 2017.
(60) Provisional application No. 62/523,972, filed on Jun. 23, 2017.

(51) Int. Cl. G06Q 40/06; G06Q 40/00

(52) U.S. Cl. CPC G06Q 40/06; G06Q 40/10

(57) ABSTRACT

A computer implemented platform for retirement planning includes a retirement accumulations module for causing to be stored a plurality of portable retirement accounts, each of which is owned by a different individual investor, for accumulating contributions from employers, sponsors and/or individual investors to each of the portable retirement savings accounts based on a respective retirement plan, and a retirement income generation module for causing to be paid to one or more of the individual investors available income payments based on the portable retirement accounts of the individual investors. The platform further includes a client computing device storing a retirement savings application configured to interact with the retirement accumulations module and the retirement income generation module that allows an individual investor to input data and information, change contributions to a respective retirement savings account, and/or cause funds to be withdrawn from the respective retirement savings account.

### CROSS-REFERENCE TO RELATED APPLICATIONS

This patent application claims benefit under 35 U.S.C. § 119(e) of co-pending U.S. Provisional Patent Application No. 62/459,239, filed Feb. 15, 2017, and also claims the benefit under 35 U.S.C. § 119(e) of co-pending U.S. Provisional Patent Application No. 62/523,972, filed Jun. 23, 2017, the entire contents of which are hereby incorporated by reference herein.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the United States Patent and Trademark Office files or records, but otherwise reserves all copyright rights whatsoever.

### TECHNICAL FIELD

This disclosure relates generally to systems and methods that provide a platform for financial planning, investment management and, more particularly, retirement management.

### BACKGROUND OF THE INVENTION

There are numerous options available for long-term retirement savings. Traditionally, these options are government or employer sponsored qualified plans such as, for example, 401(k) plans or other investment and savings plans. When an employer acts as a sponsor of such plans, the employer assumes significant risk to ensure its sponsored plan is in compliance with often complex regulatory requirements set by, for example, the Internal Revenue Service, the Department of Labor, ERISA laws, or the like. In summary, regulatory mandates are seen to require the employer to execute certain fiduciary duties to plan participants such as, for example: to select investment options for participants to choose from; to keep adequate records tracking the employer's contributions to their employees' retirement savings as well as employees' additional contribution or withdrawals from the plan; and to provide timely notifications of various events and/or changes in the law or options under the sponsored plan. On balance, most employers find the risk and fiduciary duties unduly burdensome, costly and inefficient.

Accordingly, there is a need for an improved financial planning, investment management and, more particularly, retirement management systems and methods that significantly reduce, if not eliminate, the above-described risk and undesirable fiduciary duties while also optimizing income and services to key marketplace stakeholders including, for example, Consumers, Financial Planners, Employers and Retailers, described in more detail below.

### SUMMARY OF THE INVENTION

According to one embodiment of the present invention, a computer implemented platform for retirement planning includes a communications module for receiving and transmitting data and information, a data storage device operatively coupled to the communications module for storing the data and information, and a a retirement accumulations module for causing to be stored in the data storage device a plurality of portable retirement accounts, each of which is owned by a different individual investor, for accumulating contributions from employers, sponsors and/or individual investors to each of the portable retirement savings accounts based on a respective retirement plan. The platform also includes a retirement income generation module for causing to be paid to one or more of the individual investors available income payments based on the portable retirement accounts of the individual investors, wherein the communications module, the retirement accumulations module and the retirement income generation module are configured and operating within one or more processors operatively coupled to the data storage device. The platform further includes a client computing device connected to the one or more processors, the client computing device storing a retirement savings application configured to interact with the retirement accumulations module and the retirement income generation module, the retirement savings application including features to allow an individual investor to perform at least one of: inputting data and information related to the individual investor's retirement goals, changing contributions to a respective retirement savings account, and causing funds to be withdrawn from the respective retirement savings account.

According to another embodiment of the present invention, a method of retirement planning includes receiving, by a communications module, data and information regarding a plurality of individual investors, and storing in a data storage device the data and information, storing a plurality of portable retirement accounts, each of which is owned by a different individual investor, and accumulating, by a retirement accumulations module, contributions from employers, sponsors and/or individual investors to each of the portable retirement savings accounts based on a respective retirement plan. The method also includes paying, by a retirement income generation module, available income payments to one or more of the individual investors based on the portable retirement accounts of the individual investors, wherein the communications module, the retirement accumulations module and the retirement income generation module are configured and operating within one or more processors operatively coupled to the data storage device. The method further includes performing one or more actions by an individual investor via a client computing device connected to the one or more processors, the client computing device storing a retirement savings application configured to interact with the retirement accumulations module and the retirement income generation module, the one or more actions including at least one of: inputting data and information related to the individual investor's retirement goals, changing contributions to a respective retirement savings account, and causing funds to be withdrawn from the respective retirement savings account.

### BRIEF DESCRIPTION OF THE DRAWINGS

FIG. 1 depicts examples of participants in an embodiment of a financial planning, investment management and retirement management platform according to the present invention;

FIG. 2A depicts an embodiment of a computer system that executes functionality of a financial planning, investment management and retirement management platform according to the present invention;

FIG. 2B depicts an embodiment of a computer system that executes functionality of a financial planning, investment management and retirement management platform according to the present invention;

FIG. 3 depicts aspects of an embodiment of a retirement strategy and associated retirement savings plan offered via the computer system and the financial planning, investment management and retirement management platform of FIGS. 2A and 2B;

FIG. 4 depicts investment types and options for the retirement strategy and retirement savings plan of FIG. 3 as presented to a consumer;

FIG. 5 depicts investment types and options for the retirement strategy and retirement savings plan of FIG. 3 as presented to an employer;

FIG. 6 depicts an example of an asset allocation plan for the retirement savings plan of FIG. 3;

FIG. 7 is a functional diagram depicting aspects of an example of a retirement account and examples of account funding mechanisms;

FIG. 8 depicts an example of stakeholders' participation in the accumulation phase and the withdrawal or decumulation phase of a user's retirement account over a period of the user's life;

FIGS. 9A-9C (collectively referred to as “FIG. 9”) depict examples of displays generated by a financial planning, investment management and retirement management application;

FIGS. 10A-10C (collectively referred to as “FIG. 10”) depict examples of displays generated by a financial planning, investment management and retirement management application;

FIGS. 11A-11C (collectively referred to as “FIG. 11”) depict examples of displays generated by a financial planning, investment management and retirement management application; and

FIGS. 12A-12C (collectively referred to as “FIG. 12”) depict examples of displays generated by a financial planning, investment management and retirement management application.

### DETAILED DESCRIPTION

In one aspect, the systems and methods of the present invention provide a financial planning, investment management and retirement management platform 10 (referred to herein as a “Lifetime Income Platform”). In one embodiment, the Lifetime Income Platform 10 is a web-based platform. The Lifetime Income Platform 10 simplifies and enhances long-term retirement saving and income generating processes for individual investors, referred to herein as “consumers” (e.g., individuals eighteen (18) years or older,), and increases and optimizes savings, income and services to all stakeholders in a marketplace (e.g., consumers, financial planners, employers and retailers).

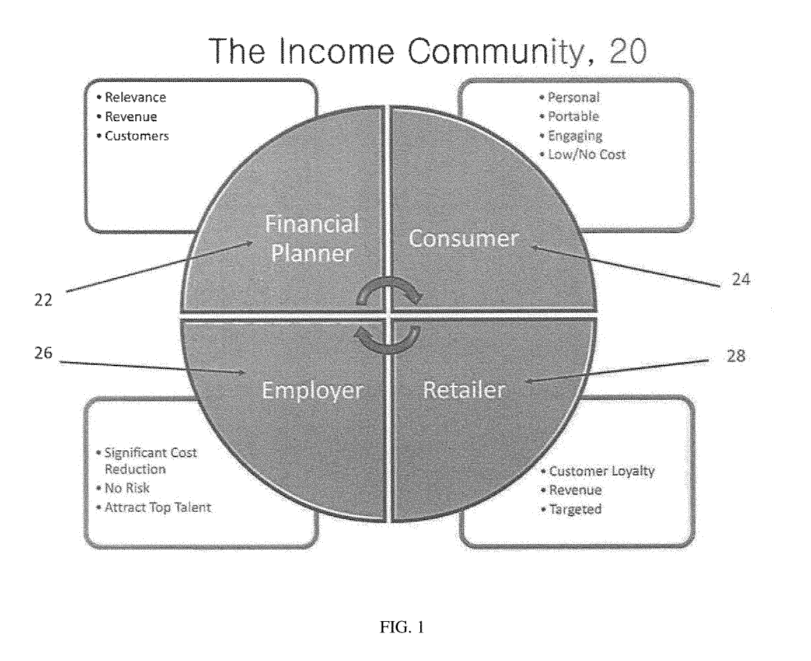

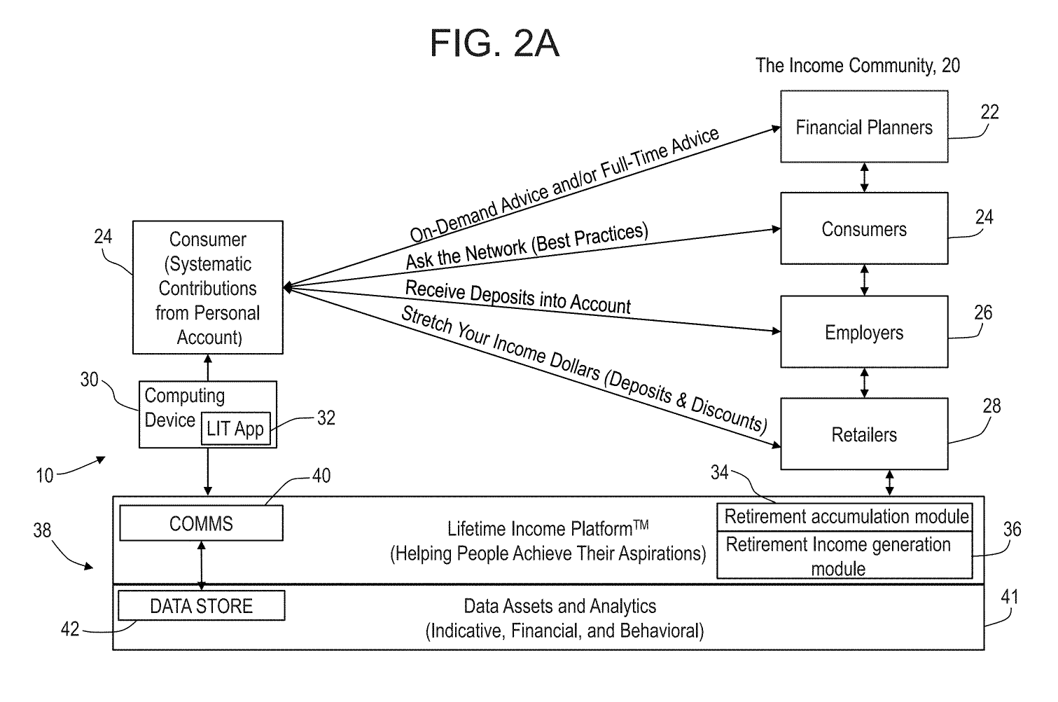

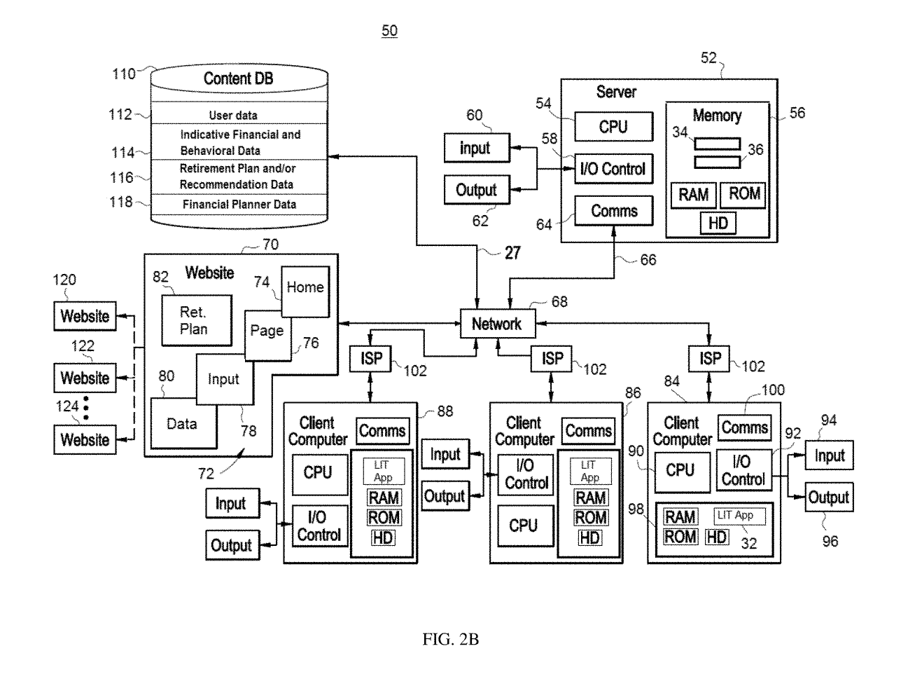

FIGS. 1, 2A and 2B show aspects of the Lifetime Income Platform 10. As shown in FIG. 1, the Lifetime Income Platform 10 s accessible by various stakeholders such as consumers, employers, retailers, financial planners, brokers and others. For example, as shown in FIG. 1, the Lifetime Income Platform 10 services a relevant Income Community 20 including stakeholders such as Financial Planners 22, Consumers 24, Employers 26, and Retailers 28. It should be appreciated that in accordance with one aspect to the present invention, the Consumers 24 are the core customers of the Lifetime Income Platform 10, and can leverage the Lifetime Income Platform 10 to review and select retirement plans that maximize their long-term retirement savings and resulting retirement income stream to provide a preferred retirement lifestyle. In one embodiment, Consumers 24 can participate in the Lifetime Income Platform 10 at relatively little or no cost. As noted above, the Lifetime Income Platform 10 supports portability such that access to participate in retirement plans in the Lifetime Income Platform 10 is available as the Consumer 24 moves from one Employer 26 to another. The inventors have discovered that employees in the current economy are more mobile and move from employer to employer. In many cases, employees may be self-employed, freelancing their services to one or more employers at a time. Accordingly, it is particularly valuable to these “mobile” employees/investors (e.g., Consumers 24) to have one or more portable retirement plans that are available as they move between employers and/or offer services to one or more employers at a time.

Referring to FIG. 2A, aspects of the Lifetime Income Platform 10 are executed by a processing or computing device 30, such as a server, desktop computer, laptop computer and/or mobile device. In one embodiment, the Lifetime Income Platform 10 includes a retirement savings application, referred to herein as a Lifetime Income Technologies (LIT) application or program 32, or “LIT app,” which is stored in the computing device 30 and operatively coupled to a retirement accumulation module 34 and an income generation module 36, which can be executed by the computing device 30 or another computing device such as a server computer 38. The Lifetime Income Platform manages the LIT app 32, the retirement accumulation module 34, the income generation module 36, one or more other modules for performing various functions (e.g., data input and output modules, display modules, recommendation modules and others) and portable retirement plans (e.g., plans that remain serviceable, i.e., “travel” with an investor/employee, as the employee moves from one employer to another) via, e.g., a communications (“COMMS”) module 40.

In one embodiment, structured and unstructured data and information 41 is collected by the Lifetime Income Platform 10 via the COMMS module 40 and is stored in a data storage device 42 at or accessible by the server computer 38 (e.g., in server computer memory, a local database and/or a remote database).

In one embodiment, the Lifetime Income Platform 10 utilizes user-friendly applications, including mobile applications, to maximum convenience and accessibility to the Consumers 24. In one embodiment, the Consumers 24 each operate a respective computing device 30 (e.g., workstation, laptop, tablet, mobile phone or other device) to execute the LIT app 32, which is operatively coupled to the server computer 38 executing the COMMS module 40, the retirement accumulation module 32 and the income generation module 36, to create, review and/or modify their investment and/or retirement account(s) on the Lifetime Income Platform 10. In one embodiment, the Lifetime Income Platform 10 provides access for Consumers 24 to participant/invest in a predetermined number of investment funds within plans, for example, funds that have little to no market risk, some market risk, or more market risk. In one embodiment, the investment funds are selected to maximize returns (e g, minimizing or eliminating cost) to Consumers 24 as well as convenience in selection and/or administration of the Lifetime Income Platform 10, e.g., plans that include funds that receive only “after-tax” contributions from either the Employers 26 or Consumers 24, which may lower record-keeping and regulatory overhead cost.

FIG. 2B shows an embodiment of a computing system 50 configured and operated to implement instructions or algorithms of the Lifetime Income Platform 10. The system 50 includes a server computer or server 52 having a server central processing unit (CPU) 54, server memory 56 that can include random access memory (RAM), read only memory (ROM), a hard drive (HD), and the like, an input/output (I/O) controller 58 operatively coupled to an input device 60 such as a keyboard, mouse, light pen or other pointing device, a document, card and/or other medium reader or scanner, and an output device 62 such as a printer, a touchscreen display, a monitor and/or other display device. The input and output devices 60 and 62 facilitate input and output of data and information to and from the system 50.

The server memory 56 stores one or more modules for performing various functions of the Lifetime Income Platform 10. For example, the server memory 56 stores the retirement accumulation module 34 and the retirement income generation module 36.

The server 52 may be connected by, e.g., an electronic communication apparatus (COMMS) 64, for communicating (as indicated by reference numeral 66) with a computerized communication network 68 such as, for example, the Internet, an intranet, an extranet, or like distributed communication platform connecting computing devices over wired and/or wireless connections.

As shown in FIG. 2B, the server 52 may host a user interface such as a web site 70 having one or more graphical user interfaces (GUIs) 72 including, for example, a home page GUI 74, a website page GUI 76, an input GUI 78 (e.g., for inputting consumer information), a data and analytics GUI 80 (e.g., for displaying consumer information, other stakeholder information and/or analysis results), a retirement plan GUI 82 (e.g., for displaying plan information, plan options, balances, allocations, etc.) and others. It is noted that the GUIs used and/or generated by the Lifetime Income Platform 10 are not limited to those shown in FIG. 2B or limited to those discussed herein.

The web site 70 or pages therefrom may be requested by users of the Lifetime Income Platform 10 through designation of a Uniform Resource Locator (URL) identifying the web site 70 (e.g., www.lifetimeincometechnologies.com), and provides access to the server 52 from other computing devices on the network 68. The GUIs are generally written in a language that permits a graphical presentation of data and information (text, images, audio, video, and the like) to persons operating a computing device. Languages include for example, the Hyper-Text Markup Language (HTML), Extensible Markup Language (XML) or another Standard Generalized Markup Language (SGML), as are generally known in the art.

As shown in FIG. 2B, the server 52 is connected to the network 68 along with one or more user or client computers 84, 86 and/or 88, which are operable by Consumers 24 and/or other users to access the Lifetime Income Platform 10 or components thereof. Each of the user or client computers 84, 86 and 88 includes a user computer central processing unit (CPU) 90, an I/O controller 92 operatively coupled to an input device 94 such as a keyboard, mouse, light pen or other pointing device, a document, card and/or other medium reader or scanner, and an output device 96 such as a printer, a touchscreen display, a monitor and/or other display device. Each of the user or client computers 84, 86 and 88 has computer memory 98 that can include RAM, ROM and a hard drive (HD). The computer memory stores suitable modules, algorithms and/or programs for accessing functionality of the Lifetime Income Platform 10, such as the LIT app 32.

Each of the user or client computers 84, 86 and 88 also includes a communication (COMMS) apparatus 100 for communicating with the server 52 over the network 68. The COMMS 100 can include a modem or a connection to a local area network (LAN), either of which can access an internet service provider (ISP) 102 through a wired or wireless communication line such as a telephone network, television cable lines, satellite links, DSL lines, or the like. The user or client computers 82, 84 and 86 may each be an IBM-type or Apple Personal Computer (or compatible analogs thereof) suitable for running a browser program for accessing and communicating over the network 68 including, for example, a workstation, laptop, notebook, tablet or other portable computing devices such as a smart phone, or the like.

As noted above, the computers 52, 84, 86 and 88 can include the electronic communication apparatus 64 and 100, respectively. The term “electronic communication apparatus,” as used herein, refers to an apparatus that facilitates electronic communication with another computer using a selected interconnection mechanism, such as a telephone network, a LAN, an intranet, or the Internet, and a selected communication protocol, such as V.90 or V.32, or in the case of the Internet, TCP/IP. The electronic communication apparatus can also include wireless or IR communication mechanisms. Electronic communication apparatus also includes circuitry that provides parallel, serial, Scsi, USB, Firewire, and other such ports known in the art, and protocols such as, but not limited to, Appletalk. The foregoing are merely examples of electronic communication apparatus, and the present invention is not limited to these examples.

The server 52 and/or the user or client computers 84, 86 and 88 may access a content database 110, so that users can access data and information relevant to the Lifetime Income Platform 10. For example, the content database 110 stores user data 112, indicative financial and behavioral data 114, retirement plan and/or recommendation data 116, financial planner data 118 and others.

In one embodiment, the data and information is presented in one or more customizable GUIs 72 to the user or client computers 84, 86 and 88 for exhibition on the output device 96 such as a display device. As is generally known, the content database 110 can include data and information stored remotely (e.g., in a separate server) or locally (e.g., in the memory 56 of the server 52), and can also include links or pointers to data and information available elsewhere, such as on other sites (e.g., web sites 120, 122, 124, or the like) on the network 68.

In one embodiment, structured and unstructured data and information is collected by the Lifetime Income Platform 10 via, e.g., the COMMS module 40 or 64, and is stored in a data storage device at or accessible by the server, such as the data storage device 42 and/or the content database 110. In one embodiment, the data and information is based on, for example, indicative financial and behavioral data 114 of members of the Income Community 20 (e.g., Consumers 24 and/or Employers 26). In one embodiment, indicative data and information 114 is stored in a data storage device and includes, for example, a Consumer's 24 name, date of birth, residence, profession and the like, and financial data and information such as the Consumer's 24 compensation, level of investment, cash flow analysis (what amounts are invested and when), and the like. The indicative data and information 114 may also include behavioral data and information such as the Consumer's 24 interests, hobbies, buying patterns in terms of preferred retailers, income consumption patterns, and the like. The indicative data and information 114 may be input by the Consumer 24 via, e.g., the Input GUI 78, and/or may be accessible from other sources.

In one embodiment, the Lifetime Income Platform 10 utilizes facial recognition technology to collect indicative data and information 114. For example, a facial recognition module or other device executes an algorithm to detect an individual user (e.g., a Consumer 24) and locate the individual user's financial information and lifestyle information. The module, upon identifying a user, automatically retrieves user information from, e.g., the database if user has previously entered information, or from a different source, e.g., employer records, medical records, social media, etc. For example, a user can login into the Lifetime Income Platform using the LIT app 32 by looking into a camera, and the system 50 will present the user with information such as the user's current income, identifying information like name, date of birth and an associated a video/image based on the user's past interests (e.g., a beach).

In one embodiment, the Lifetime Income Platform 10 can access general economic, social and other macro-data including, for example, social and market trends, employment rates, interest rates and the like. The Lifetime Income Platform 10 may also access data regarding employers, retailers, plan administrators, financial planners and other entities. For example, data regarding Financial Planners 22 (e.g., the financial planner data 118) may include, for example, investment strategies (where to invest) to address particular problems or needs of investors under their supervision. Such information may be used by the Lifetime Income Platform 10 to, for example, generate and share certain “best practices” in advancing investors' goals. In one embodiment, data regarding Employers 26 may include, for example, a number of employees, a typical or average duration/tenure of their employees, investment contributions (percentage and as compared to the market in general or competitive employers or industries), and the like.

In one embodiment, analytics may be run to evaluate the data and information to support such features as, for example, a customer loyalty program, personalized or targeted marketing based on, for example, life events of one of the Consumers 24 that may have driven a change in investment/retirement strategy, such as the birth of a child, the death of a spouse, a job change and others. As should be appreciated, the evaluation of the data and information collected by the Lifetime Income Platform 10 may be used by, for example, the Retailers 28 to identify a new marketing channel and/or target audience for their goods and/or services based on the aforementioned indicative, financial and/or behavioral data previously not available to them.

In one embodiment, the Lifetime Income Platform 10 allows the marketplace stakeholders (e.g., the Financial Planners 22, Consumers 24, Employers 26 and Retailers 28) to interact and communicate formally with personalized messaging, or informally by posting and answering general bulletin board, peer-to-peer question and answer or chat messaging via social media or the like. The inventor recognizes that fostering a community exchange enhances aspects of the Lifetime Income Platform 10 and may lead to ratings (e.g., likes/dislikes), acknowledgement as a knowledgeable resource within the community, and the like. In one embodiment, the Lifetime Income Platform 10 may access other systems that offer insight to, for example, employment (e.g., part-time job boards for retirees) or more affordable living conditions (e.g., regions of the country) in order to enhance or supplement Consumers' 24 ability to maximize their retirement income stream over a period of years, including years following retirement from a primary career. It should be appreciated that it is within the scope of the present invention for the Lifetime Income Platform 10 to employ password protected access, encryption of communication and storage, e.g., an open, distributed ledger encryption such as Blockchain or other multi-source encryption algorithm, and the like, to ensure that all data and information within the Lifetime Income Platform 10 is secure from unauthorized access and/or duplication or modification.

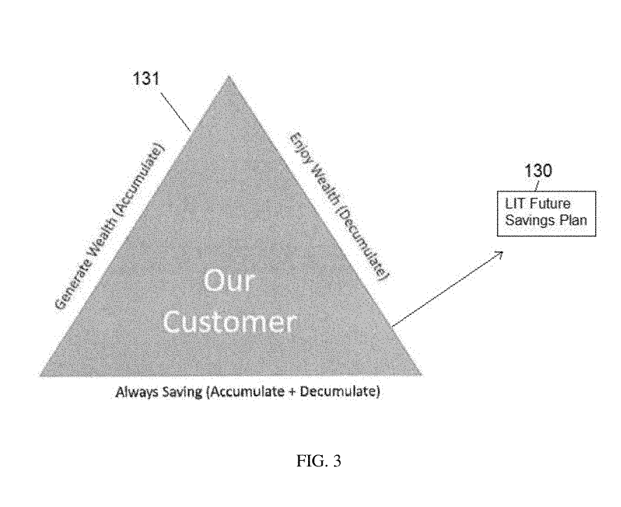

The Lifetime Income Platform 10 supports individualized retirement savings plans that are portable and customized to an individual investor (e.g., a Consumer 24). In one embodiment, illustrated in FIGS. 3 to 6, the Lifetime Income Platform deploys an individual saving plan referred to herein as a Lifetime Income Technologies (LIT) Future Savings Plan 130. As shown in FIG. 3, a retirement strategy 131 can be employed to generate the LIT Future Savings Plan 130 or parts thereof. The LIT Future Savings Plan 130 (also referred to as the LIT Plan) is advantageous in that it provides a plan tailored to the consumer independent of the consumer's employer, in contrast to conventional retirement savings plans that are customized for an employer and allow for a range of investments tied to 401K, Roth 401K and Individual Retirement Account (IRA) types of investments. Such conventional plans have been designed and built as employer centered, which causes complexity in plan definition and the costs associated to manage the plans. In contrast, the Lifetime Income Platform 10 provides an individual saving plan that is common across employers and is consumer centric.

In one embodiment, the LIT Plan 130 (generated, e.g., using the retirement strategy 131) is a single plan, i.e., a plan customized to an individual Consumer 24 (either individually or as a family plan), which may be an Employees Retirement Income Security (ERISA) plan or a non-ERISA plan, depending on the consumer's tax situation. In one embodiment, the LIT Plan 130 is free (or has relatively small to no cost) to the Consumer 24 and is partitioned by an Employer 26 and/or other stakeholders. This is very different from conventional environments where every 401K plan is unique to an employer with unnecessary complexity. The LIT Plan 130 reduces the cost for the Employer 26 significantly and maintains a consistent experience for the consumer over their lifetime, thereby avoiding the several mistakes that consumers make today (e.g., take money out, pay taxes and penalties) every time they have a change of employment status.

An Employer 26 can determine the amount and frequency of contributions made by the Employer 26 to a Consumer's 24 retirement savings account associated with the LIT Plan 130. The amount may be tied to contribution amounts made by the Consumer 24 (e.g., directly or through withholding), or independent of the Consumer's 24 contributions, as discussed further below. In one embodiment, the Employer 26 is only responsible for administering the amount of money that the Employer 26 wants to contribute; the Lifetime Income Platform 10 (through a bank or other third party) makes the debit of money from an employer account for a specific employee to fund the employee's account. Employer 26 contributions may be made based on, e.g., the income levels and financial behavior of an employee.

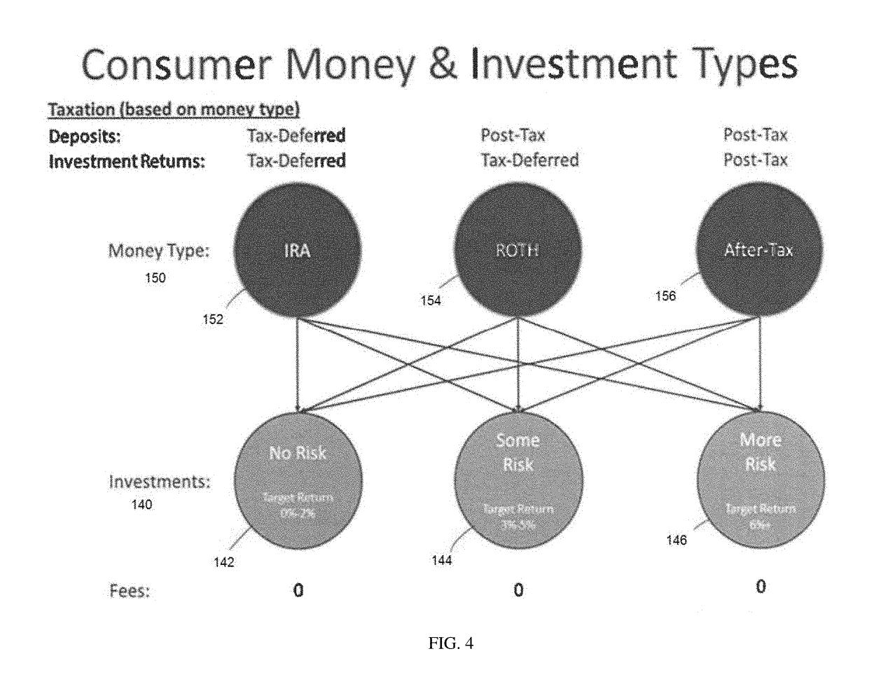

The LIT Plan 130 is portable for the individual consumer 24 as he/she moves their job from one employer to another. As shown in FIG. 4, the LIT Plan 130 may define and display one or more types or categories of investments. For example, the LIT plan 130 presents three (3) investment types 140 (e.g., low or no risk types 142, medium risk types 144, and high risk types 148 of FIG. 4). Each of the investments can be funded through one or more types of money accounts 150 (“money types”), such as an Individual Retirement Account (IRA) 152, a Roth IRA 154 and an After-Tax Plan 156. Investment into the LIT Plan 130 can be allocated to one or more of the three investment types 140 according to consumer preferences. Thus, the plan selected for the Consumer 24 with be a retirement savings plan being a selected money type 150 and a selected investment type 140. Allocation can be managed by an associated custodian, such as a bank or brokerage firm. Personal contributions can be made from one or more bank accounts of an individual. The simplicity of the LIT Plan 130 reduces the overhead and costs as compared to conventional employer plans.

The LIT Plan 130 can be funded by one or more Employers 26 without causing any termination of the plan at employment change. In one embodiment, the LIT Plan display shown in FIG. 4 (or other display offering various types of plans) can be presented to a Consumer 24 if an Employer 26 terminates the Consumer's 24 conventional (e.g., 401K) plan and replaces the conventional plan with the LIT Plan 130, or if the Consumer 24 terminates with an employer and wants to roll his or her money into the LIT Plan 130. In one embodiment, the types of money accounts 50 may be at least partially controlled by an Employer 26, so that the Employer 26 can set up the types of plans offered.

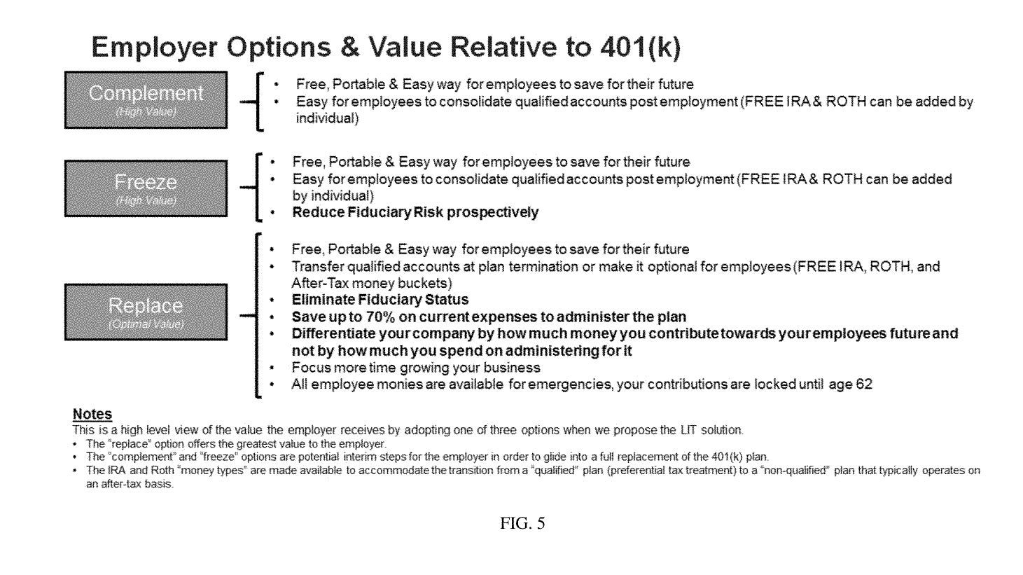

FIG. 5 shows an example of a display presented to an Employer 26 for selection of the types of retirement savings plans that the Employer 26 wishes to select for the Employer's employees (one or more of the Consumers 24). In one embodiment, although the employee may select the investment type 140, the Employer 26 selects the money type 150. For example, the display in FIG. 5 shows three options: a “complement” option, a “freeze” option and a “replace” option. All of these options present a (potentially free) portable and easy way for an employee to save for his or her retirement. The complement option and the freeze option make it easy for employees to consolidate qualified accounts post-employment. The complement option offers only post-tax type plans (e.g., After-Tax Plan 156) and provides an employee two choices for investment (risk) types: a low or no risk type 142 and a medium risk type 144. The freeze plan again offers only post-tax type plans (e.g., After-Tax Plan 156) and provides an employee three choices for investment (risk) types: a low or no risk type 142, a medium risk type 144 and a high risk type 146. The complement and freeze options are potential interim steps for the Employer 26 to glide into a full replacement of a current 401K plan. The replace option allows the Employer 26 to offer all three money types 150 and allows an employee to select from all three investment types 140. It is noted that the above options and the number and type of investment choices are merely examples. For example, the complement option may be constructed such that all three of the above options are available to an employee or other user.

Allocation of consumer funds into plan types can be based on various factors, such as a Consumer's 24 behavioral data, age, risk appetite, income level and others. The Lifetime Income Platform 10 can automatically allocate funds to plan types based on pre-existing information, such as recommendations and consumer preferences, and/or can recommend allocations to a consumer. In one embodiment, the Lifetime Income Platform 10 uses a method of allocation based on an algorithm for future projections of employability. For example, if the likelihood of automation greatly impacting a job in a future time period (e.g., the next 5 years) is high, a system executing the Lifetime Income Platform 10 recommends a safer allocation. This system may be operatively coupled with a data intake module, a data output module, and a visualization module.

The Lifetime Income Platform 10 may set and/or recommend a savings rate. The savings rate may be an amount of money contributed by a Consumer 24 to a retirement plan per a selected period (e.g., weekly or monthly), a percentage of the Consumer's income or other measure. In one embodiment, the LIT Platform 10 includes a Defined Benefit Contribution™ Rate (“DBC Rate”) as a contribution methodology. In the US retirement system, conventional 401(k) plans match employee contributions based on their percentage of salary. In one embodiment of the LIT Platform 10, the Platform 10 does not require the employee (e.g., Consumer 24) to save/defer income to receive a contribution from the employer 26. The LIT Platform 10 allows the creation of personalized retirement benefit plans focused on retirement goals, to meet the individual needs of an employee, with the target savings responsibility shared by the employer and the employee. The DBC Rate determines the employer contribution and can be adjusted for multiple income ranges.

The LIT Platform 10 can be leveraged to determine the recommended savings rate for an individual based on his/her annual income and lifestyle. For example, The LIT Platform 10 models that the income saving rate for a healthy lifestyle in retirement is between 10% and 15%. The DBC Rate 76 is computed as a constituent amount of the savings rate or total contribution, e.g., as a percentage of the savings rate. Employers 26 may be asked to define the DBC Rate instead of matching it based on the percentage of the individual's monthly salary. The LIT Platform 10 can be leveraged, via a DBC Rate calculation tool, by the employer 26 to model/budget contributions for their employees 24 based on annual income brackets (e.g., brackets of $5,000-$10,000) for their specific employee population. The DBC Rate, for example, will range from 0%-100% of the target saving rate (10%-15%). The LIT Platform 10 pricing model for the employer 26 discounts based on the level of DBC Rate that the employer makes for individuals with annual incomes less than, for example, $100,000. Other income thresholds, for example, up to $180,000, may be implemented.

The DBC Rate can be defined for the various income slabs such that a reverse discrimination benefit can be provided based on compensation or employment type. Employers 26 can set multiple income slabs, each having a specific DBC Rate, and a minimum eligibility period for the benefit to be available. In one embodiment, an employer 26 can set an additional contribution for one or more of their employees 24 as a Behavior Contribution. Additional contributions by an Employer 26 and/or other stakeholder (e.g., a Retailer 28) may be based wholly or in part on a rating or score generated for the Consumer 26. In one embodiment, a unique score or rating is generated for each Consumer 24 or other individual investor having a retirement savings account. The score or rating may be based on, e.g., an individual's income, lifestyle and/or savings characteristics (e.g., amount and/or percentage of income contributed to a retirement savings account). The score or ratings may be in any suitable form, such as a numerical value, a number of stars or other ratings indicators, a graphical score (e.g., different colors), etc.

This additional contribution may be funded to the future employee's savings, subject to, e.g., their FUMON rating (described below). This can act as a financial incentive for the employee to adapt positive behavior, e.g., positive financial wellness behavior. It should be appreciated that similarly, incentives can be funded within the LIT Platform 10 and other stakeholders to encourage positive wellness behavior and the like.

As an example, a typical DBC rate for an employer 26 may include:

| | | | | | | Fulltime |
|---|---|---|---|---|---|---|
| | | | | | | (FT) or |
| | DBC Rate | Financial | | | Minimum | Part-time |
| Salary | (% of | Wellness | Industry | Recommended | Eligibility | (PT) or |
| Range | Recommended | Behavior | DBC | Savings % | Period | Contractor |
| ($) | Savings) | Contribution | Benchmark | ($) | (months) | (C) |
| $30000-$40000 | 70% | 10% | 70% | 10% | 12 | FT |
| | | | | ($3000-$4000) | | |
| $30000-$40000 | 60% | 10% | 68% | 10% | 24 | PT |
| | | | | ($3000-$4000) | | |
| $40001-$60000 | 65% | 10% | 70% | 10% | 24 | FT, PT |
| | | | | ($4001-$6000) | | |

The savings rate and one or more contributions can be recommended, set and/or adjusted based on various factors related to, e.g., consumer behaviors. For example, the Lifetime Income Platform 10 performs a method and algorithm for funding a future retirement savings account based on the percentage of personal spending transactions. The Lifetime Income Platform 10 identifies spending transactions by a consumer from a linked personal account (e.g., a checking account) and debits an amount to the retirement savings account from the linked personal account based on a percentage of spending set by the consumer. In another example, the Lifetime Income Platform 10 performs a method and algorithm for funding a future retirement savings account based on a percentage of deposit transaction amounts. The Lifetime Income Platform 10 identifies deposit transactions and debits an amount from the linked personal account to the retirement savings account based on a percentage set by the user. In yet another example, the Lifetime Income Platform 10 performs a method and algorithm for funding a future retirement savings account by debiting the linked personal account for a fixed amount per period, e.g., on a specific day of the month. The Lifetime Income Platform debits an amount to the retirement savings account from the linked personal account based on the date and amount set by a user.

In one embodiment, the Lifetime Income Platform 10 performs a method and algorithm for funding a future retirement savings account by debiting a consumer's linked personal account (e.g., checking account) and contributing to the retirement savings account an amount corresponding to a difference between an amount spent by the consumer and a maximum amount or ceiling (e.g., to the nearest integer). The Lifetime Income Platform 10 debits the amount from the linked personal account to the retirement savings account by finding the nearest ceiling value for each spent value and taking the difference from the actual spent value.

In addition to periodic contributions to a consumer's retirement savings account, the Lifetime Income Platform 10 can make one-time contributions or contributions tied to specific events. For example, the Lifetime Income Platform 10 performs a method and algorithm for funding a future retirement savings account of a consumer (who is a member of the Platform) based on a successful referral by the consumer to the Lifetime Income Platform 10. The Lifetime Income Platform 10 identifies whether the referred person joined the Lifetime Income Platform 10 and credits the Consumer 24 who made the referral. The Lifetime Income Platform 10 may identify whether the referred person made a required number of contributions and credits the consumer who made the referral when the required number of contributions is met. In another example, the Lifetime Income Platform 10 performs a method and algorithm for funding a future retirement savings account based on a contest. An example of such a contest is a quiz. The Lifetime Income Platform 10 presents a quiz or other contest to assess consumer behaviors, and a percentage of the consumers who respond to the quiz correctly get a deposit towards their retirement savings accounts.

In one embodiment, the LIT Platform 10 provides a novel personal contribution methodology. The LIT Platform 10 defines an incremental savings approach for the personal contributions made by an individual. The LIT Platform 10 employs methods to determine that for an individual X % of personal contribution (systematic or lump sum) of the total income is required with a Y % incremental increase every year, up to a Z % maximum. The X, Y and Z values are personalized to an individual based on income, lifestyle and savings.

In one embodiment, the LIT Platform 10 employs a “Future Paycheck” model. For example, individuals are presented with their possible future paycheck per month instead of them chasing a target savings number. The future paycheck summary shows the amount of money that can be withdrawn for a specific period. Individual can adjust the amount or time frame for their paycheck. Individuals can view the impact to their future paycheck based on the changes in the contribution or investment allocation.

In one embodiment, the Lifetime Income Platform executes a method and algorithm for “backsolving” for retirement by having the user select a target “future paycheck” amount. This comprises an algorithm for calculating and presenting several scenario options that include different recommendations for savings amounts laid out over time. This method may be performed by the retirement plan module 82 or another module such as the retirement accumulation module 34 or a contribution module, and includes an ability to select one of the recommendations. In this case, an individual sets a target future paycheck amount, and an optimization algorithm provides a number (e.g., at least three) scenarios for how to get there (for instance, by providing a linear combination of “reduce expenses, earn more, contribute a larger percentage”). The target future paycheck amount may be adjusted by the user and/or automatically by the Lifetime Income Platform 10 over time based on factors such as salary or income, expected growth in investments, expected growth in salary or income, tax data (e.g., changes in tax rates due to legal changes or changes in income) and others.

In one embodiment, the LIT Platform 10 employs a Contribution Lockup. The Contribution Lockup makes all contributions made directly by the Consumer 24 readily accessible based on the money type. All contributions made to the Consumer's retirement savings account from an external source are locked up with no access to withdraw until a certain age. In one embodiment, the Lifetime Income Platform 10 sets a standard withdrawal age as 62 years, although any desired age may be selected.

The LIT Platform 10, in one embodiment, includes a FUMON™ Rating (Individual Financial Rating Method). For example, the LIT Platform 10 defines a FUMON rating for an individual based on the income, lifestyle and savings using a scoring scheme. This rating provides an easier way of analyzing an individual's financial health and appropriate recommendation is generated to set improvement guidance.

The FUMON rating is an indicator that would measure the individual's investment behavior towards their “Future Money (FUMON)”. In one embodiment, the FUMON rating is a star rating, i.e., a rating corresponding to a number of stars out of a maximum, for example, five stars. In one embodiment, each star represents one of the following:

Systematic contributions from checking/savings into the Lifetime Income Platform 10 (e.g., at least monthly);

No withdrawals for a selected period (e.g., the past 12 months);

Savings percentages in the top 50% (or other percentage) of the Consumer's 24 base;

Completion of a personal profile to optimize the Lifetime Income Platform 10 experience; and

Total contributions from all sources equal to a set percentage (e.g., at least 10%) of income annually.

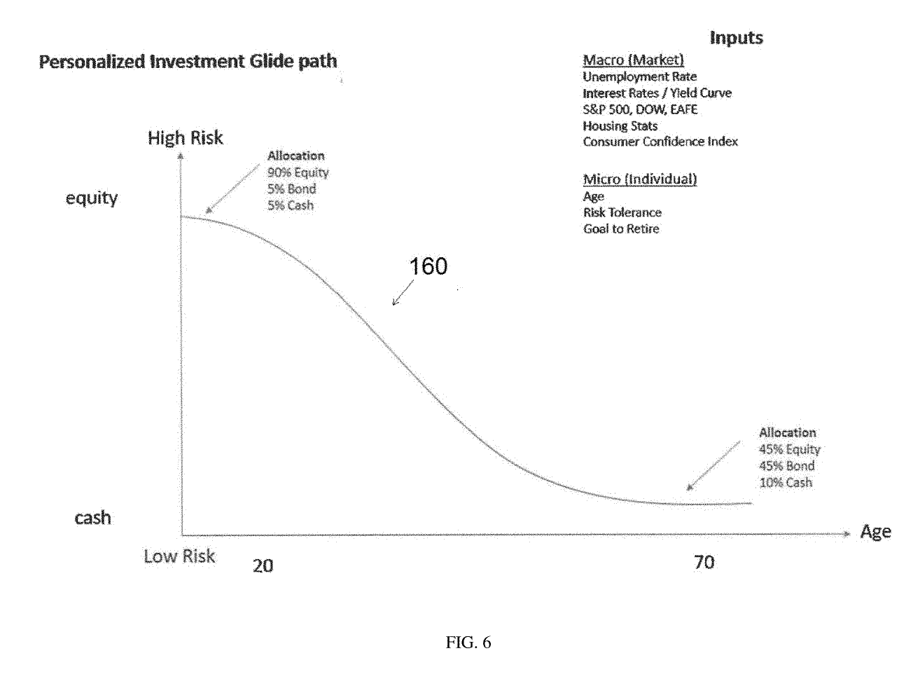

Referring to FIG. 6, in one embodiment, the Lifetime Income Platform 10 utilizes a personalized investment glide path as an investment method. The investment glide path may be personalized for each individual investor based on factors such as time, risk, proposed retirement age, and/or allocation and rebalancing of the investment portfolio across the low, medium and high risk investments.

For example, the Lifetime Income Platform 10 defines a unique glide path allocation strategy, illustrated as curve 160, to guide the allocation of funds across investment types, for an individual's investments. The strategy is based on the retirement age and market conditions. The current retirement investment of choice is a “target date” fund, which ends with a more conservative investment allocation as the fund gets closer to the date of the fund coming to maturity.

In the Lifetime Income Platform 10, the systems and methods take factors such as time, risk, proposed retirement age, and an allocation and rebalancing algorithm that will personalize an investment glide path for an individual starting as early as age eighteen (18) and maturing at a desired age (e.g., seventy years). In the example shown in FIG. 6, the allocation strategy prescribes the allocation of funds to three specific (e.g., no fee) funds, i.e., cash, bond and equity funds. In the early years, the allocation strategy is relatively high risk, allocating funds as 90% equity, 5% bond, and 5% cash. This allocation has a glide path (curve 160) that becomes more conservative as the individual ages up to age seventy, where it would conclude with 45% bonds, 45% cash, and 10% equity.

In one embodiment, the Lifetime Income Platform 10 includes recommendation analytics. The LIT Platform 10 recommendation engine (e.g., the recommendations module stored in memory 56) works to promote savings and increase the outcomes of the individual tailored to the future savings.

Examples of recommendations that can be generated by the Lifetime Income Platform 10 include one or more of the following:

A recommendation regarding an increase or decrease in suggested contributions based on salary increase or decrease;

A recommendation regarding an increase or decrease in suggested contributions based on an industry benchmark;

A recommendation regarding an increase or decrease in suggested contribution based on a retirement paycheck goal. A “paycheck” is a periodic (e.g., weekly, bi-weekly or monthly) payment to a consumer from the consumer's retirement accounts, and a paycheck goal is an amount of the payment desired after retirement;

A recommendation regarding an increase or decrease in suggested allocation for the three investment categories based on retirement age;

A recommendation regarding health and wellness behavior tied to the future financial health based on a health profile;

A recommendation of a financial advisor or advisors based on the individuals' financial needs and target advisor profile; and

A recommendation regarding product and service discounts based on the current and future financial profile of an individual.

In one embodiment, the Lifetime Income Platform 10 includes rewards for future savings. For example, the Lifetime Income Platform 10 rewards positive financial or wellness behavior to achieve rewards towards a consumer's future retirement account.

In one embodiment, the Lifetime Income Platform 10 executes a method of recommending an increase or decrease in an individual investor's future paycheck (a payment amount selected for future retirement) as a function of social security income. As an example, if a Consumer 24 delays the social security payout from 62 to 70 years, the social security income almost doubles and that is increased much further with the added income through the Consumer's 24 account. The Consumer 24 is proactively reminded of these benefits and recommendations are made.

In one embodiment, the Lifetime Income Platform 10 performs a method of recommending an increase in an individual investor's personal contribution based on data collected from the usage of a retirement savings calculators and other retirement planning tools provided. As an example, if a Consumer 24 is checking the future paycheck amount by entering a variation of income and increased or decreased contribution, from their current income or contribution defaults, the Lifetime Income Platform 10 analyzes the pattern, and generates a recommendation to assist the decision of increasing contribution or generates a recommendation to avoid the decision of decreasing contribution.

In one embodiment, the Lifetime Income Platform 10 performs a method of separating investment availability based on individual account balances. For individuals with a certain threshold balance, the Lifetime Income Platform 10 (e.g., via a recommendations module) automatically provides additional functionality to allow investments in more advanced funds. Further, based on an individual financial rating, this option is made more or less difficult to access (e.g., by setting a limit on the number of allocation changes that can be made, by increasing or decreasing the number of GUIs or screens that must be navigated, and others).

In one embodiment, the Lifetime Income Platform 10 performs a method of tying accounts to spouses or partners to achieve common long-term savings goals for positive behavioral reinforcement. A partner module or other module tracks individual and joint goals, a recommendations module provides recommendations, and another module provides additional financial education. The method may require “joint agreement”, i.e., a positive action that both spouses or partners must take to change contribution amounts, allocations and/or goals. For example, each spouse executing a respective application pushes a button that appears on both applications, to raise the contribution amount for both partners (e.g., by an additional 1% per year), and the contribution amount is changes when both partners click the button on their respective accounts. Once a first respective button is pressed by one partner, the other partner is notified by their preferred method of communication (e.g., email or text) and in-application next time they log in, to make a choice. Further, this embodiment may include a separate progress-tracking screen for partner choices distinct from the regular screen. Additionally, “linked” apps have an option to enable a simplified overview of both accounts to be viewed in either account (such overview comprising one or more of totals, a future paycheck, contribution recommendations, and contribution levels, as well as additional educational information on achieving joint long-term goals).

In yet another embodiment, the Lifetime Income Platform 10 allows members of the Income Community 20 to cooperate to expand the core mission of retirement planning. Stakeholders other than the Consumer 24, such as Employers 26, Retailers 28 and/or other third parties to provide benefits to the Consumer 24. These benefits include, for example, a potential increase of the Consumer's future income paycheck and/or providing actions or services that make a Consumer's 24 paycheck in retirement last longer if possible. The following are examples of such benefits:

Job Placement Service (JPS): A system that identifies jobs for Consumers 24 that may help supplement income and/or provide adequate benefits. The jobs may be identified by various categories or characteristics (e.g., geography, skill, requirements, etc.), and the JPS may assist in job placement. A fee may be collected for each successful placement.

The Trader Bucket List: A community bartering system that allows Consumers 24 to place goods and services with their respective values in exchange for other goods and services, as opposed to exchange for cash. Everyone has stuff they no longer use/need or can provide services (e.g., a haircut). This system contributes to a sustainable lifestyle in retirement, by facilitating trade for something of equal value without having to spend retirement income. A fee may be collected for each trade.

The Money Back Consumption Card: A Consumer 24 can sign up for the card and use it for everyday expenses with all money back going into the Consumer's retirement savings account to increase future income.

The Lifetime Income Platform 10, in one embodiment, facilitates or performs income distribution from a Consumer's retirement savings account during retirement. The Consumer 24, when ready to generate retirement income, can take out periodic dollar amounts, arbitrary amounts, can set a systematic draw-down rate (e.g., 4% to 5%), a guaranteed lifetime income paycheck through a fixed annuity, remain invested, and/or hire a professional advisor to manage the payout phase for the Consumer 24. Regardless of method, the Lifetime Income Platform 10 may illustrate the implications of each to that specific Consumer 24.

The Lifetime Income Platform 10, in one embodiment, includes modules and/or functionality for aiding a Consumer 24 in making choices regarding investment allocation, savings rates and/or income distribution. In one embodiment, the Lifetime Income Platform 10 performs a method for discouraging early withdrawal of funds based on individual behavior. For example, if an individual has a low “financial rating” based on account balance and savings history, there may be a number of warnings presented to the individual, such as a warning on each of a selected number of screens or GUIs (e.g., one to five). The number of warnings/screens and the length of explanatory text, as well as color choices are tied to an algorithm of user behavior (e.g., the FUMON rating). For an individual with a low tier rating, there may be a timed cooling-off period (e.g., at least 15 minutes to 24 hours) before a negative change can be implemented, and/or a limit on changes within a period. For example, the Lifetime Income platform 10 only allows a downward change in allocation at a maximum of once per day, dependent on rating. Additionally, if the magnitude of a change is calculated to exceed a set limit, said limit to be determined by the FUMON rating or another algorithmic method, there can be a trigger to call into a support center to unlock the method and discourage allocation changes.

Another method that can be performed by the Lifetime Income Platform 10 is a method for adjusting a difficulty of selecting a withdrawal based on an individual investor's goals, financial behavior of the individual investor and/or recommended levels of savings. For example, the Lifetime Income Platform 10 (via, e.g., the retirement income generation module 36) can set the difficulty of making changes in “recommended” directions (e.g., increasing contributions) to be less than the difficulty in making changes in “not recommended” directions (e.g., decreasing contributions, early withdrawals), so that the difficulty is unbalanced. For example, if a Consumer 24 wants to increase a monthly contribution, the window or GUI used by the Consumer 24 has one readily visible on-screen control, such as a large confirmation button with text in a “positive” color (e.g. green or blue). If the Consumer 24 wants to decrease a contribution, the Lifetime Income Platform requires one or more additional windows with information on the impact to the future paycheck and a warning prior to a confirmation screen, said screen to be in a “negative” color (e.g. red) and have multiple options (e.g., agree, cancel, or wait). The agree button is the smallest and below the others, whereas the cancel button is largest and above the others. The option to wait implements a cool-down period, where the Lifetime Income Platform 10 asks for a final decision in a selected time period (e.g., no fewer than 15 minutes), at which point the same screen pops up with an option to cancel the order (as a larger button) or to proceed (with a smaller button).

An action away from the recommendation in the negative direction may automatically trigger an invitation to return to the previous state within a selected time period after the change (e.g., between one week and one month after the change).

The Lifetime Income Platform 10 may include functionality to encourage behaviors that would help achieve a Consumer's 24 goals. For example, The Lifetime Income Platform 10 presents a pictorial representation of financial achievements based on an algorithm for current and future projections of lifestyle, aspirations, income and spending. For example, if an individual aspires to retire on a beach front in Florida, and is working towards that lifestyle, the Lifetime Income Platform 10 will represent that with a picture that is changing over the future course of time. For example, the picture may have colors or brightness that changes as the Consumer 24 nears a goal, or a portion of the picture is shown, with the portion increasing as the Consumer 24 nears the goal.

In one embodiment, the Lifetime Income Platform 10 may also include a Lifetime Income Technologies (LIT) Trust Account. For example, the Employer 26, Retailer 28 or another one or more of the stakeholders in the Income Community 20 can fund a LIT trust account on behalf of all the stakeholders (e.g., Employers 26 and Consumers 24) as a part of the LIT plan. Funds of the contributing stakeholder can also be allocated to a trust account. The funds contributed for each stakeholder may be locked until the stakeholder reaches a certain age (e.g. reaches age sixty). The funds funded by the contributing stakeholder may be available for withdrawal at any point in time. The trust funds can be invested using the LIT investment strategy and/or can be managed by the stakeholders. The Lifetime Income Platform 10 records the contributions made for or by the stakeholder towards the trust account.

In one embodiment, the Lifetime Income Platform 10 may also include an Individual Trust Account. For example, the Employer 26, Retailer 28 or another one of the stakeholders in the Income Community 20 can fund an Individual trust account on behalf of a Consumer 24 as part of the Consumer's 24 retirement plan. The funds contributed from any of the stakeholders may be locked until the Consumer 24 reaches a certain age (e.g., the age of sixty). The funds funded by the contributing stakeholder may be available for withdrawal at any point in time. The trust funds can be invested using the LIT investment strategy and/or can be managed by the Consumer 24. The Lifetime Income Platform 10 may record the contributions made for or by the Consumer 24 toward the trust account.

In one embodiment, a structure of the LIT Trust Account within the LIT Platform 10 is as follows. The trust operates as an investment fund with a purpose of paying out retirement benefits. The trust may be structured as a for-profit or not-for-profit vehicle regardless if it is structured at an individual or institutional level. In one embodiment, a preferred investment thesis requires a long-term view of projected liabilities to pay benefits and thus is invested accordingly. The trust may have parameters of operations including, by example:

Records kept on a quarterly basis as a minimum (daily maximum);

Fully transparent;

100% funded;

Proceeds from external stakeholders may be released to consumers at a selected age, e.g., sixty;

Proceeds deposited by any stakeholder/consumer may be liquidated at any time;

Bonus pool multiplier: additional monies deposited by external stakeholders may be segregated for a specifically identified population as an incentive to drive personal savings behavior. For example, assume a Consumer 24 has a 100,000-dollar ownership in the trust at age 62. At point of unlocking those funds for the benefit of the Consumer 24, the Lifetime Income Platform 10 may use the bonus multiplier to determine if the Consumer 24 is eligible for an additional payout. Assume the bonus pool was funded at 10% and the monies may be distributed based on personal savings behavior throughout their membership with the Lifetime Income Platform 10. That personal savings behavior may be measured daily with a rating (e.g., a FUMON 5-star scoring system rating) that emphasizes a need to consistently save and not withdraw funds. At point of distribution (e.g., age 62), the $100,000 may be eligible for a multiplier based on the Consumer's 24 behaviors. Assuming the behavior was positive, the Consumer 24 could end up with a payout of, e.g., $110,000 vs $100,000;

Taxes are applied at the consumer level once they turn a selected age and based on their annual draw down or income payout vs the total balance; and

No more than 1% of the trust fund may be used to support operations of the fund.

In one embodiment, the Lifetime Income Platform 10 may include life insurance for a Consumer 24 or another stakeholder. For example, the Lifetime Income Platform 10 may purchase insurance for the Consumer 24 (like Corporate Owned Life Insurance (COLI), but the premiums are paid for by the LIT Trust and NOT the employer 26 and therefore the insurance is owned by the LIT trust) of an employer where the beneficiary of the policy may be the LIT Trust account. The premiums may be paid by the Lifetime Income Platform 10. The coverage may be $X and a percentage of that coverage may be paid to the stakeholder as a death benefit. X % of the claim amount generated in the trust account may be used to pay the premium and Y % may be credited to the stakeholder's retirement account to increase retirement savings.

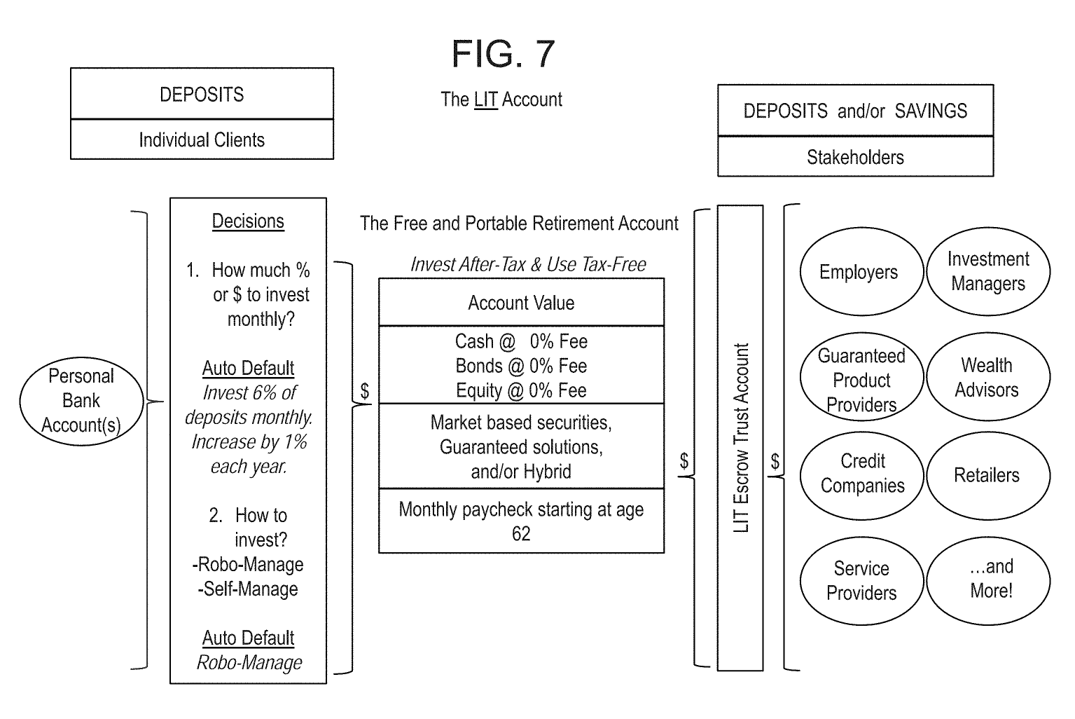

FIG. 7 is a functional diagram that shows aspects of an example of a retirement account 170 that can be offered to a Consumer 24 via the Lifetime Income Platform 10, and examples of account funding mechanisms. The diagram illustrates how the retirement account 170 is funded through the Consumer's 24 personal accounts 172 and through other stakeholders. As illustrated in this example and discussed above, various stakeholder can make contributions to a Consumer's 24 retirement account for various reasons. Stakeholders making contributions are also referred to herein as “sponsors,” which may include employers, retailers, service providers and others. For example, a retailer may make periodic or one-time contributions as a reward for shopping there, or a credit card company may make periodic contributions to reward positive consumer financial behavior (e.g., making on-time payments, reducing balances, etc.)

In this example, contributions in the form of consumer deposits are applied to the retirement account 170, based on parameters set by a plan set for the Consumer 24, e.g., the retirement plan 130. Parameters include how much to contribute (e.g., a percentage of income or a selected amount of money) and how often (e.g., monthly, bi-weekly, etc.), whether and how much to increase the contribution over time, and how the retirement account funds are invested (e.g., self-managed or automatically managed by a planner or algorithm). Default settings may be pre-selected and adjustable by the Consumer 24.

Other stakeholders or sponsors 174 may also contribute to the retirement account 170, such as employers, investment managers, guaranteed product providers, wealth advisors, credit companies, retailers, service providers and others. Contributions may be made based on, e.g., a Consumer's 24 financial behavior and/or consumer behavior (e.g., purchase of products or services). For example, retailers may make contributions as a reward or incentive for purchases or use of credit cards or other goods and services. In one embodiment, other stakeholders or sponsors 174 contribute via an intermediary account, such as a LIT Trust Account 176.

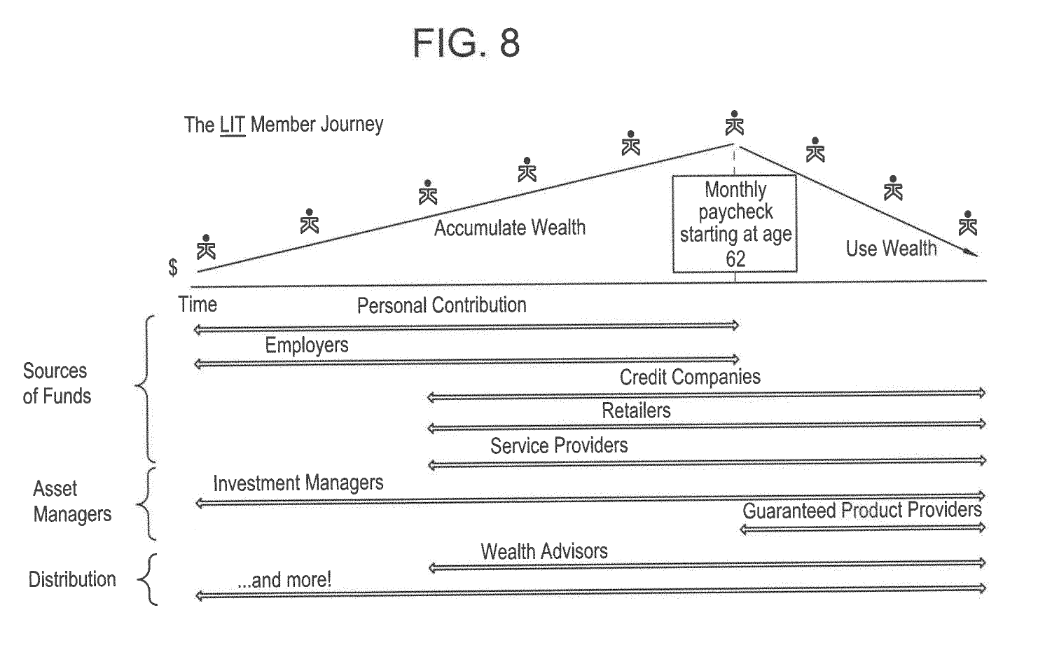

FIG. 8 shows a timeline representing accumulation to and withdrawals from a user's retirement account, and illustrates how retirement savings can be accumulated through a user's life. As shown, sources of funds for the user may include personal contributions and employer contributions during the user's working life prior to retirement. Multiple employers may contribute to the user's single account, which travels with the user and is not contingent on employment. User and employer contributions may continue after retirement, e.g., if the user takes part-time, freelance or other employment during retirement. Other sources of funds, both before and during retirement, may include contributions from various stakeholders (e.g., credit card companies, retailers and service providers). Asset managers such as investment managers may manage the investments targeted by the retirement account (e.g., via the glide path 160), and guaranteed product providers (e.g., annuities) pay the user after retirement. Wealth advisors may also be involved to facilitate allocation decisions and plans.

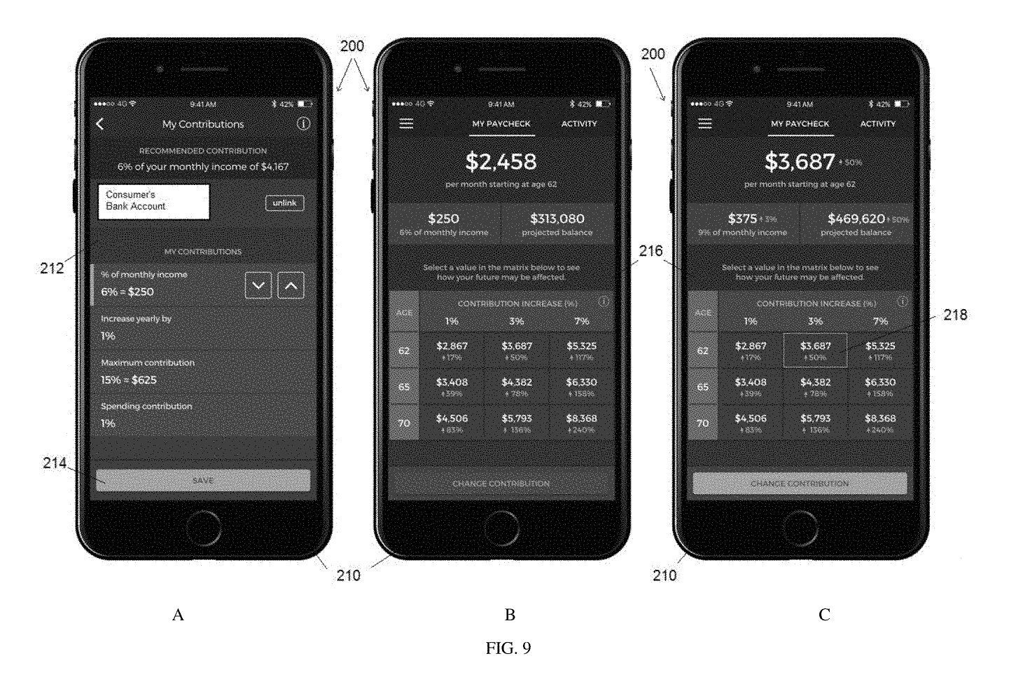

FIGS. 9-12 show examples of various displays 200, 300, 400 and 500 generated by a financial planning, investment management and retirement management application, such as the LIT app 32. In these examples, the displays are provided on respective mobile devices 210, 310, 410 and 510 having a touchscreen display, but may be generated using any computing device (e.g., the computing devices 84, 86 and/or 88 of FIG. 2B). These examples include displays presented to a Consumer 24 or other user. It is noted that the data, properties of the user's retirement plan (e.g., amount and frequency of contributions, retirement “paycheck” goals, age for withdrawal, withdrawal amounts and frequency at retirement, etc.) and other information may be customizable or adjustable by the user.

FIG. 9A shows a “My Contributions” screen 212 that displays properties of a user's retirement plan, including a user's account from which contributions are paid and contribution amounts. The “My Contribution” screen 212 shows a recommended contribution and actual contributions, which may be changed by the user. In this example, the user's retirement plan includes a monthly contribution of 6% of the user's income, a yearly increase in contributions by 1%, a maximum contribution, and a spending contribution of 1% of user spending. The display identifies one or more user accounts from which money is contributed to the user's retirement account. A “save” button 214 can be used to enter changes. FIGS. 9B and 9C show examples of a “My Paycheck” screen 216 that shows a future periodic fixed payment amount (a “future paycheck”), such as $2,458 or $3,687, as set by the user, and shows current contributions (e.g., $250 or 6% of monthly income, or $375 or 9% of monthly income). The “My Paycheck” screen 216 also shows how the future paycheck amount would change if contributions are increased and/or the retirement age is changed. As shown in FIG. 9C, a recommendation 218 may be made regarding contribution increases (e.g., percentage, frequency and/or amount) and/or retirement age changes that would be needed to achieve the user's future paycheck goal. A “Change Contribution” button allows the user to change properties of the retirement plan.

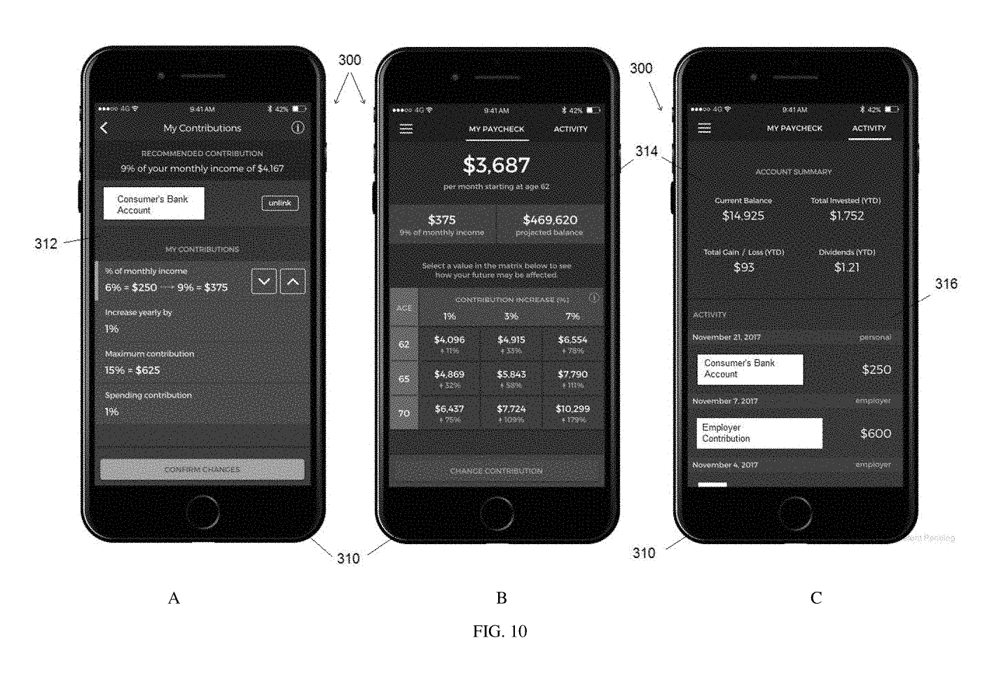

FIG. 10A shows an example of a “My Contributions” screen 312 of a display 300 of a mobile device 310 that displays retirement plan properties and shows an amount of a monthly contribution if the recommended contribution is used (e.g., an increase to 9% of monthly income would result in an increase in monthly contributions from $250 to $375). FIG. 10B shows a “My Paycheck” screen 314 similar to that discussed above. The “My Paycheck” screen 314 or another screen, an example of which is shown in FIG. 10C, shows information regarding the user's retirement account, including current balance, year-to-date (YTD) total contributions, gains or losses YTD and dividends YTD. An “Activity” display 316 shows contributions to the retirement account and identifies the sources of the contribution (e.g., the user and one or more employers).

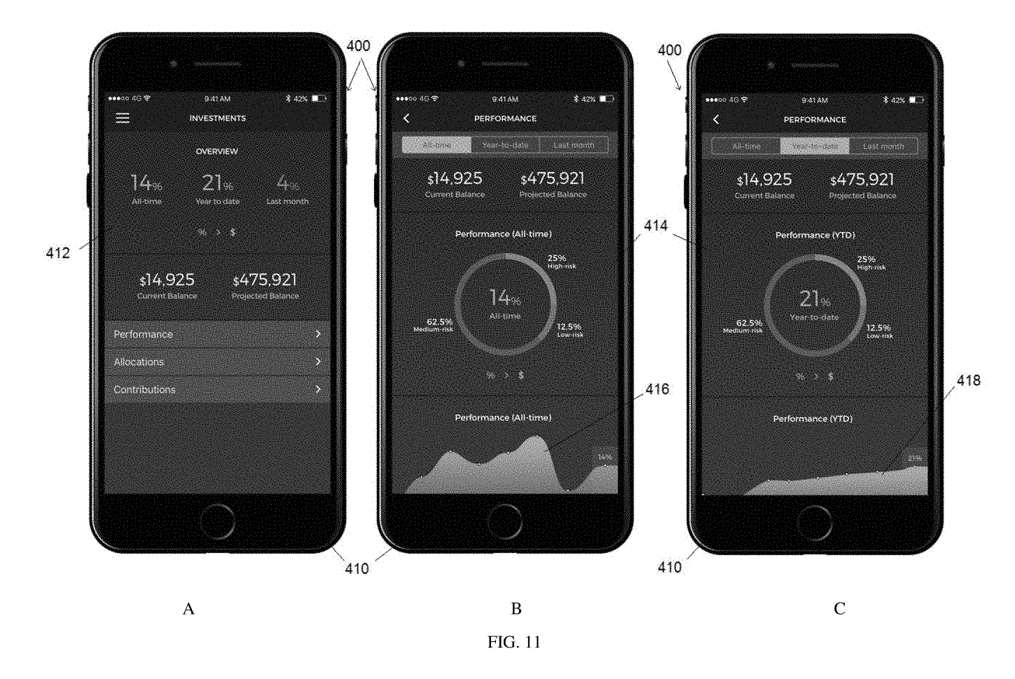

FIG. 11A shows an example of an “Investments” screen 412 of a display 400 of a mobile device 410, which shows the retirement account current balance, projected balance at retirement, and how much the retirement account value has increased. The “Investments” screen 412 also includes interface elements such as buttons or drop-down menus, which the user can access to get more detailed information regarding the retirement account and plan. FIGS. 11B and 11C depict a “Performance” screen 414 that shows performance over a selected time period (e.g., all-time, YTD and last month) and shows the allocation of funds into different types of investments (e.g., high risk, medium risk and low risk). FIG. 11B includes a graphical representation 416 (e.g., a curve at the bottom of the screen) showing the all-time performance (increase or decrease in value) of the retirement account, and FIG. 11C includes a graphical representation 418 of the YTD performance.

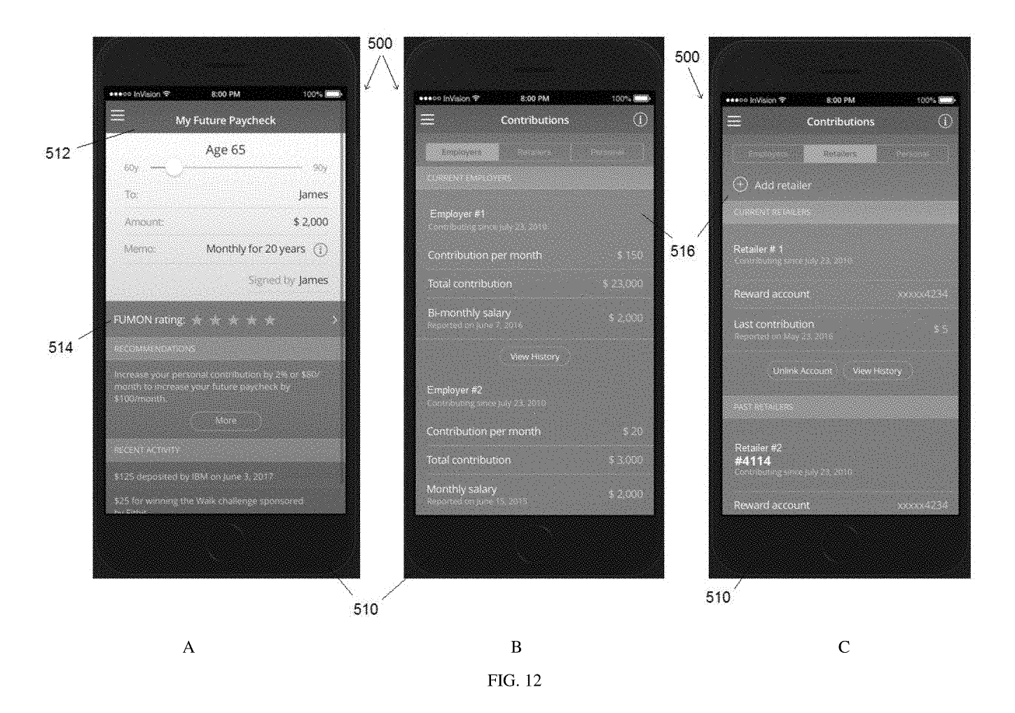

FIGS. 12A-12C show another example of a display 500 of a mobile device 510 that can be presented to a user via the LIT app 32 or other suitable program forming part of the Lifetime Income Platform 10. FIG. 12A shows a “My Future Paycheck” screen 512 that provides information regarding an amount and frequency of a user's desired future paycheck, and may also include information such as the user's financial rating 514 (e.g., the FUMON rating), recommendations and recent contribution and withdrawal activity. FIGS. 12B and 12C show an example of a “Contributions” screen 516. The “Contributions” screen identifies current employers that are contributing to the retirement account (as shown in FIG. 12B), and identifies current and past retailers and/or other stakeholders that are or have contributed to the retirement account (as shown in FIG. 12C).

The Lifetime Income Platform 10 (and/or a Consumer 24 or other user) can change the Consumer's 24 future paycheck amount across the timeline of the age of the Consumer 24 using various criteria. For example, the future paycheck amount can be automatically updated or recalculated based on changes in salary income, expected growth of investments, expected growth in salary income, tax data and others.

As shown in FIG. 12, the Lifetime Income Platform 10 supports contributions from multiple employers into a single account, which is portable with the user and not tied to any employer. The employers may be current employers and/or past employers.

Existing 401k system contributions are based on the percentage of salary of an employee and amounts of personal contributions from the employee. Once the employee relationship terminates, the contributions stop from the employer but the account can remain. However, the employee ends up having another account after being employed by another employer, which can lead to fragmented balances. Secondly, if the employee is working with multiple employers, contributions from the employers go to different accounts, and all of the employers pay administrative charge for their respective accounts. Typically, employers contribute to a 401k account of an employee which is tax deferred.

In the Lifetime Income Platform 10, there is one account held for a user (although a user may have the option to open multiple accounts if desired). Anyone can open a retirement account via the Lifetime Income Platform 10, whether they are working with an employer or not, have more than one employer, or whether they are a 1099 contract worker. Users can make their own personal contributions to their retirement accounts independent of employer. In addition, anyone can sponsor a contribution towards the member's retirement account. Sponsors (e.g., employers, retailers, service providers, etc.) can start or stop contribution at any time.

The Lifetime Income Platform 10 may impose rules for the money that sponsors contribute to the user's account. One such rule can be that the portion of money that is in the user's account from the sponsor is locked until a selected age, e.g., the age of 62. In one example, a user can only receive a contribution from a specific sponsor, if the user meets eligibility rules for that contribution to be made. One such eligibility rule from a retailer sponsor can be that the user must shop according to a selected frequency (e.g., at least once per month) to be eligible for the contribution from the retailer.

One or more embodiments of the present invention have been described. Nevertheless, it will be understood that various modifications may be made without departing from the spirit and scope of the invention. Accordingly, other embodiments are within the scope of the following claims.

What is claimed is:

1. A computer implemented platform for retirement planning, comprising:
a communications module for receiving and transmitting data and information;
a data storage device operatively coupled to the communications module for storing the data and information;
a retirement accumulations module for causing to be stored in the data storage device a plurality of portable retirement accounts, each of which is owned by a different individual investor, for accumulating contributions from employers, sponsors and/or individual investors to each of the portable retirement savings accounts based on a respective retirement plan; and
a retirement income generation module for causing to be paid to one or more of the individual investors available income payments based on the portable retirement accounts of the individual investors, wherein the communications module, the retirement accumulations module and the retirement income generation module are configured and operating within one or more processors operatively coupled to the data storage device; and
a client computing device connected to the one or more processors, the client computing device storing a retirement savings application configured to interact with the retirement accumulations module and the retirement income generation module, the retirement savings application including features to allow an individual investor to perform at least one of: inputting data and information related to the individual investor's retirement goals, changing contributions to a respective retirement savings account, and causing funds to be withdrawn from the respective retirement savings account.

2. The computer implemented platform of claim 1, wherein the retirement accumulations module and the retirement income generation module are each configured to provide an output signal to a display device, the output signal indicative of a balance and/or periodic income at predetermined age intervals, within the respective retirement savings account of the individual investor.

3. The computer implemented platform of claim 1, wherein at least one of the retirement plans prescribes or suggests periodic contributions to the respective retirement savings account, the periodic contributions selected based on a desired amount of a future periodic paycheck to the individual investor from the respective retirement savings account upon retirement.

4. The computer implemented platform of claim 1, wherein the individual investor is an employee of an employer, the retirement accumulations module is accessible by the employer to select an amount to be contributed to the respective retirement savings account by the employer, and the respective retirement savings account associated with the employee is specific to the employee and is independent of the employer.

5. The computer implemented platform of claim 4, wherein the respective retirement savings account associated with the employee is sponsored and administered by one or more third parties different from the employer, the respective retirement savings account being funded by contributions made by at least one of the employer, a past employer and a third party.

6. The computer implemented platform of claim 4, further comprising a display module configured to offer choices to be selected for a retirement plan associated with the individual investor, the choices including a first set of choices for a money type of the associated retirement plan and a second set of choices for an investment type of the associated retirement plan, the investment type selectable by the employee and the money type selectable by the employer.

7. The computer implemented platform of claim 4, wherein the retirement accumulations module is configured to set a periodic contribution amount to the respective retirement savings account based on a retirement goal of the individual investor, the periodic contribution amount including a constituent amount to be paid by the employer and/or a sponsor, the constituent amount to be paid irrespective of contributions made by the individual investor.

8. The computer implemented platform of claim 4, wherein the retirement accumulations module is configured to procure from the employer and/or one or more other sponsors an additional contribution for the employee based on the employee's behavior.

9. The computer implemented platform of claim 1 further comprising a display module configured to offer choices to be selected for a retirement plan associated with the individual investor, the choices including selected allocations between low, medium and/or high-risk investments, the retirement accumulations module configured to automatically rebalances allocations in each of the low, medium and/or high risk investments based on selections made by the individual investor.

10. The computer implemented platform of claim 1, wherein the retirement income generation module is configured to adjust a difficulty of selecting a withdrawal based on at least one of: the individual investor's goals, financial behavior of the individual investor and recommended level of savings.

11. The computer implemented platform of claim 1, further comprising a recommendations module configured to provide recommendations as to actions that the individual investor may take after retirement to reduce the amount of money needed to be withdrawn during retirement.

12. A method of retirement planning, comprising:
receiving, by a communications module, data and information regarding a plurality of individual investors, and storing in a data storage device the data and information;
storing a plurality of portable retirement accounts, each of which is owned by a different individual investor;
accumulating, by a retirement accumulations module, contributions from employers, sponsors and/or individual investors to each of the portable retirement savings accounts based on a respective retirement plan;
paying, by a retirement income generation module, available income payments to one or more of the individual investors based on the portable retirement accounts of the individual investors, wherein the communications module, the retirement accumulations module and the retirement income generation module are configured and operating within one or more processors operatively coupled to the data storage device; and
performing one or more actions by an individual investor via a client computing device connected to the one or more processors, the client computing device storing a retirement savings application configured to interact with the retirement accumulations module and the retirement income generation module, the one or more actions including at least one of: inputting data and information related to the individual investor's retirement goals, changing contributions to a respective retirement savings account, and causing funds to be withdrawn from the respective retirement savings account.

13. The method of claim 12, further comprising providing an output signal to a display device by the retirement accumulations module and the retirement income generation module, the output signal indicative of a balance and/or periodic income at predetermined age intervals, within the respective retirement savings account of the individual investor.

14. The method of claim 12, wherein at least one of the retirement plans prescribes or suggests periodic contributions to the respective retirement savings account, the periodic contributions selected based on a desired amount of a future periodic paycheck to the individual investor from the respective retirement savings account upon retirement.

15. The method of claim 12, wherein the individual investor is an employee of an employer, the retirement accumulations module is accessible by the employer to select an amount to be contributed to the respective retirement savings account by the employer, and the respective retirement savings account associated with the employee is specific to the employee and is independent of the employer.

16. The method of claim 15, wherein the respective retirement savings account associated with the employee is sponsored and administered by one or more third parties different from the employer, the respective retirement savings account being funded by contributions made by at least one of the employer, a past employer and a third party.

17. The method of claim 15, further comprising offering choices via a display module to be selected for a retirement plan associated with the individual investor, the choices including a first set of choices for a money type of the associated retirement plan and a second set of choices for an investment type of the associated retirement plan, the investment type selectable by the employee and the money type selectable by the employer.

18. The method of claim 15, further comprising setting a periodic contribution amount to the respective retirement savings account based on a retirement goal of the individual investor, the periodic contribution amount including a constituent amount to be paid by the employer and/or a sponsor, the constituent amount to be paid irrespective of contributions made by the individual investor.

19. The method of claim 12, wherein the retirement income generation module is configured to adjust a difficulty of selecting a withdrawal based on at least one of: the individual investor's goals, financial behavior of the individual investor and recommended level of savings.

20. The method of claim 12, further comprising providing recommendations by a recommendations module as to actions that the individual investor may take after retirement to reduce the amount of money needed to be withdrawn during retirement.
